(19) United States
(12) Patent Application Publication
(10) Pub. No.: US 2011/0266009 A1
(43) Pub. Date: Nov. 3, 2011

(54) MOBILE FIRE FIGHTING CART

(76) Inventor: Tian-Chuan Liu, Hsinchu County (TW)

(21) Appl. No.: 12/773,011

(22) Filed: May 3, 2010

(51) Int. Cl. A62C 27/00

(52) U.S. Cl. 169/52

(57) ABSTRACT

A mobile fire fighting cart includes a platform, water tank, boost pump, turret, and a reel of hose. The water tank having water inlets for supplying water will supply water to the boost pump. Pressurized water by the boost pump will be supplied to fire hose, turret, or a reel of hose for putting off a fire. The wheeled platform having slots for forks can be moved manually or by a fork-lift truck, and can be received by a medium truck. The self-powered mobile fire fighting cart having functions of powered water supply, manual mobility, and availability of fire powder is such a reliable fire equipment with high mobility.

### FIELD OF THE INVENTION

The present invention relates to fire fighting cart, and particular to a low cost mobile fire fighting cart. The mobile fire fighting cart provides functions of powered water supply, manual mobility, and availability of fire powder which the prior art doesn't have.

### BACKGROUND OF THE INVENTION

Currently, plants, office and departments are installed with may different kind of fireproof devices, such as fire hydrants, fire pumps, etc. However, we are impossible to known when a fire accident will occur. For a general used PVC cable, under the voltage of 600V, the conductors at the primary side can not endure temperature over 90° C., and that for the secondary side is not over 60° C. For generators, ATSs, fire pump, emergency electric panel, tool box for fireproof, the conductors at the primary side can withstand the temperature not over 840° C. within a time period of 30 minutes and the that in the secondary side can withstand the temperature not over 380° C. with a time period of 15 minutes. However, temperature in fire scene is about 2000° C. to 2500° C., but this is not endured by PVCs, heat tolerant wires, fireproof wires.

Moreover, the fire pump is actuated under the normal electric power supply for pumping water to extinguish fire, but in fire accident, electric wires or fuse are easy to be destroyed so that the fire pump and other fireproof devices can not be actuated. Thus fire trucks are necessary. However, generally, time periods for fire trucks to arrive the fire scenes are about 15 to 30 minutes or more longer time, but within this time period, the fire become large and many equipments are destroyed. A great lose occurs. Thus it is necessary to extinguish fire within the initial 15 minutes.

### SUMMARY OF THE PRESENT INVENTION

The primary object of the present invention is to provide a self-powered fire fighting cart with highly mobility and lower cost for emergency fire fighting especially while the electricity is cut off by the fire.

The present invention provides functions of powered water supply, manual mobility, and availability of fire powder which the prior art doesn't have.

### BRIEF DESCRIPTION OF THE DRAWINGS

FIG. 1 is a piping diagram of the present invention.

FIG. 2 is a schematic view showing a mobile fire fighting cart of the present invention.

FIG. 3 is a schematic view of the mobile fire fighting cart from a lateral side.

FIG. 4 is a schematic view showing an operation of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

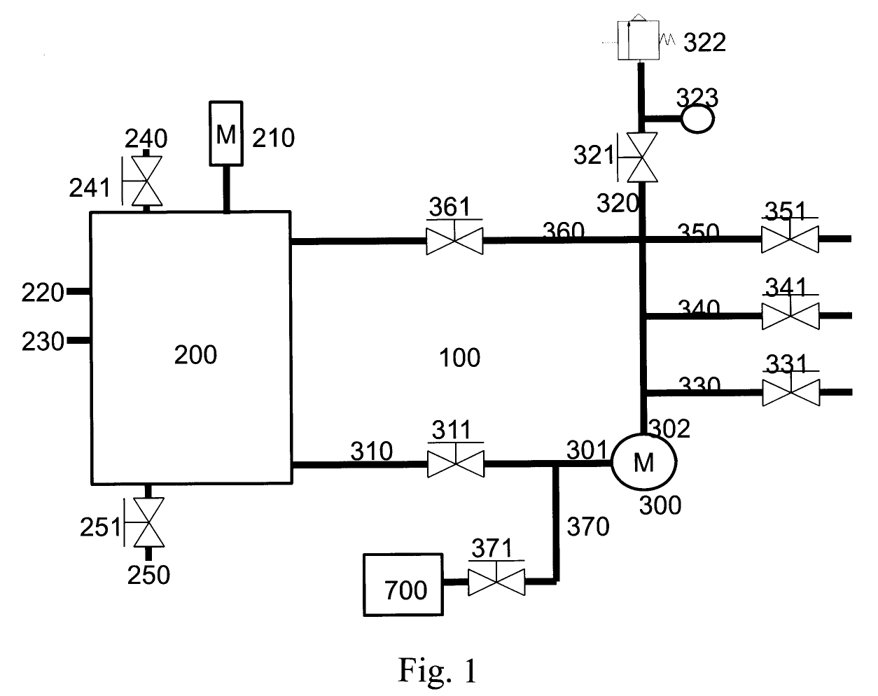

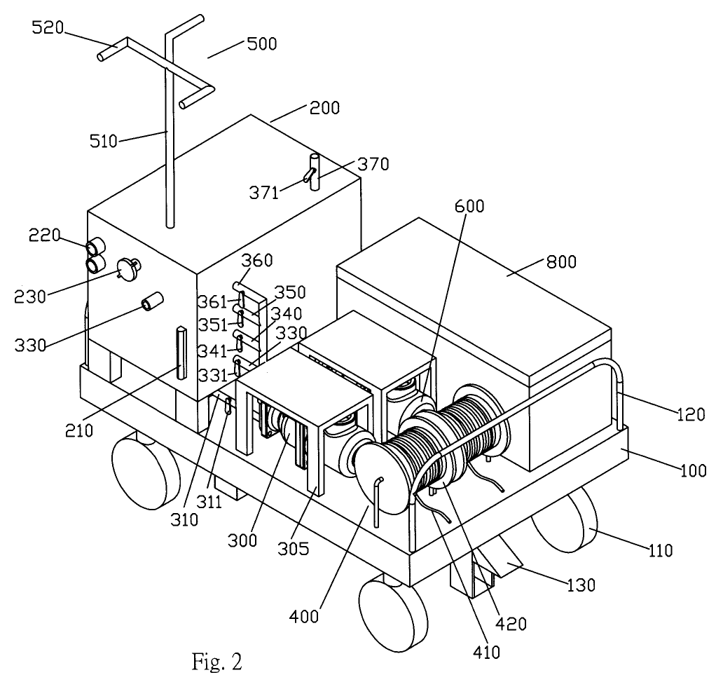

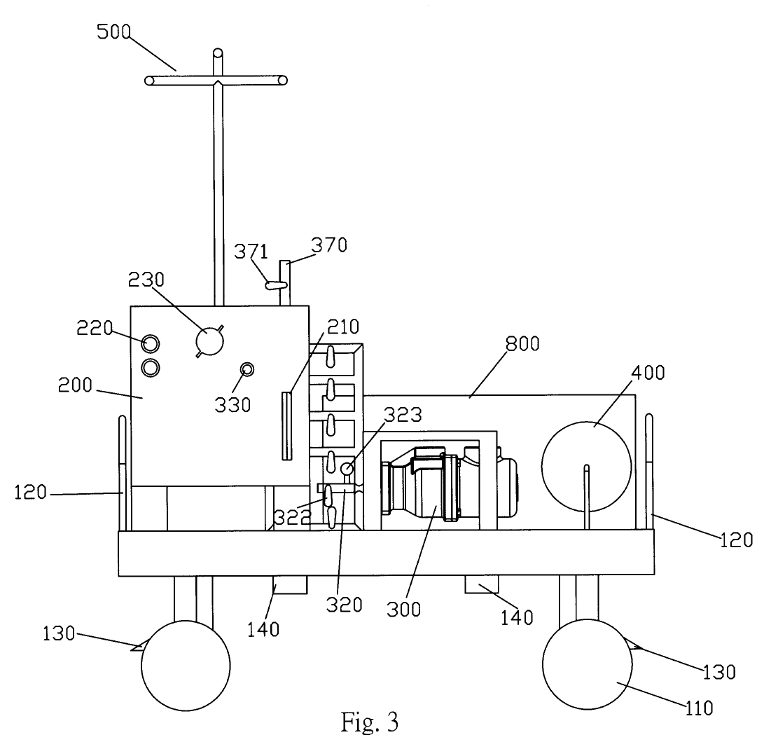

Referring to FIGS. 1 to 4, a preferable embodiment of a mobile fire fighting cart according to the present invention is illustrated. The mobile fire fighting cart includes a platform 100, water tank 200, boost pump 300, reel of hose 400, and a turret 500.

The platform 100 has four wheels 110 on a bottom of the platform 100. Two handles 120 are formed to a front and rear sides of the platform 100 respectively. Two brakes 130 are formed to a front bottom and a rear bottom of the platform 100 so as to park the mobile fire fighting cart at a location for operation. Two slots 140 are formed to a predetermined position on the bottom of the platform 100 for receiving the forks of a fork-lift truck so that the mobile fire fighting cart can be transferred by fork-lift truck. The platform 100 can be received to a medium truck for improve the mobility.

The water tank 200 is arranged upon the platform 100. The water tank 200 serves to reserve water for putting out fire. A level meter 210 is arranged to a lateral side of the water tank 200 to show the water level inside the water tank 200. A 2.5 inch coupling 220 and 4 inch coupling 230 are formed to two lateral sides of the water tank 200 for supplying water to the water tank 200. An overflow tube 240 and an overflow valve 241 are formed to an upper lateral edge of the water tank 200 for draining out excess of water being supplied so as to prevent damage to the water tank 200. A drain tube 250 and a drain valve 251 are formed to a bottom of the water tank 200 so as to drain out all the water in the water tank 200.

The boost pump 300 is fixed beside the water tank 200 on the platform 100. An inlet pipe 310 with a valve 311 linking to the water tank 200 from the bottom thereof is connected to a water inlet 301 of the boost pump 300. A piping diagram of the boost pump 300 is shown in FIG. 1. A water outlet 302 of the boost pump 300 is connected to a 1.5 inch coupling 330 with a valve 331, a reel of hose piping 340 with a valve 341, a turret piping 350 with a valve 351, and a return piping 360 linking to the water tank 200 with a valve 361. A fire foam piping 370 with a valve 371 is connected to the water inlet 301 of the boost pump 300. A safety piping 320 with a valve 321 linking to an adjustable safety release valve 322 and a pressure gauge 323 is connected to the water outlet 302 of the boost pump 300 so as to release water through the adjustable safety release valve 322 while the pressure is too high. In the embodiment, the boost pump 300 has a gas engine capable of being started by a switch or a rope. A cover 305 is placed upon the boost pump 300 and also serves to being stepped by the users.

The reel of fire hose 400 is arranged to a front edge of the platform 100. A fire hose 401 with a predetermined length is reeled in a reel 420. One end of the fire hose 410 is connected to the reel of hose piping 340, and another end of the fire hose 410 can be deployed for operation. In the preferable embodiment, two adjacent reels of hose 400 are arranged to the platform for extending a radius of operation.

The turret 500 is arranged to a top of the water tank 200. The turret 500 has a rotation axle 510 capable of rotating 360 degrees and an elevation axle 520 so as to aim up and down. The turret 500 is connected to the turret piping 350.

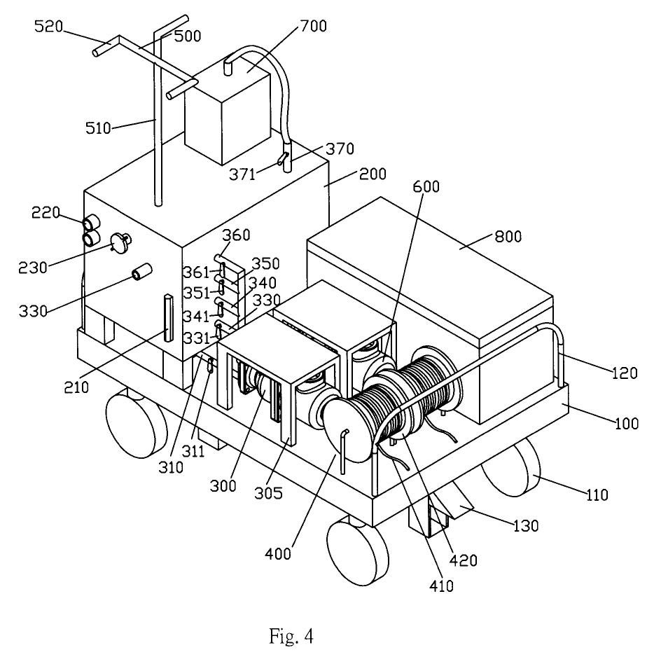

While the boost pump 300 is started for operation, the valves 311 and 361 are opened so that pressurized water is first supplied back to the water tank 200 as a cycle. Meanwhile, the valve 321 of the safety piping 320 is opened for releasing pressure while needed. Depending on the situation, one or two of the valves of the 1.5 inch coupling 330, reel of hose 400, or the turret 500 are opened with the valve 361 closing so that pressurized water will be spurted from the chosen piping. With the valve 371 of the foam piping 370 opening, foam supplied from a foam tank 700 will flow into the boost pump 300 so that water and foam will be mixed by the boost pump 300. A foam spout will be spurted from the operating piping as shown in FIG. 4.

A tool box 800 is arranged on the platform 100 for storing hoses and tools.

The mobile fire fighting cart of the present invention can be moved to the scene of fire by manual, fork-lift truck, or truck for operation. The water tank 200 can be supplied by various water sources such as a fire hydrant, or fire plug. Moreover, a water pump 600 is arranged to the platform 100 so as to pump water from a pool, water tower, or river for supply. The present invention provides functions of powered water supply, manual mobility, and also availability of fire powder which the prior art doesn't have.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A mobile fire fighting cart comprising:
a platform having four wheels on a bottom thereof; two handles being formed to a front and rear sides of the platform respectively for being moved manually; two brakes being formed to a front bottom and a rear bottom of the platform so as to park the mobile fire fighting cart; two slots being formed to a predetermined position on the bottom of the platform for receiving the forks of a fork-lift truck so that the mobile fire fighting cart will be transferred by the fork-lift truck; the platform being loaded to a medium truck for improve the mobility;
a water tank arranged upon the platform for reserving water for putting out fire; a level meter shown the water level inside the water tank being arranged to a lateral side thereof; a 2.5 inch coupling and 4 inch coupling for fire hose being formed to two lateral sides thereof for supplying water; an overflow tube with a valve being formed to an upper lateral edge thereof for draining out excess of supplied water so as to prevent damage to the water tank; a drain tube with a valve being formed to a bottom thereof so as to drain out all the water in the water tank;
a boost pump arranged beside the water tank on the platform; an inlet pipe with a valve linking the water tank from the bottom thereof being connected to a water inlet of the boost pump; a water outlet of the boost pump being connected to a 1.5 inch coupling with a valve, a reel of hose piping with a valve, a turret piping with a valve, and a return piping linking to the water tank with a valve; a fire foam piping with a valve linking to a foam tank being connected to the water inlet; a safety piping with a valve linking to an adjustable safety release valve and a pressure gauge being connected to the water outlet so as to release over-pressurized water through the adjustable safety release valve;
at least one reel of fire hose having a fire hose being reeled in a reel arranged to a front edge of the platform; one end of the fire hose being connected to the reel of hose piping, and another end of the fire hose being deployed for operation; and
a turret arranged to a top of the water tank; the turret having a rotation axis capable of rotating 360 degrees and an elevation axis to aim up and down; the turret being connected to the turret piping; and
wherein the valves of the inlet pipe and the return piping are opened while the boost pump is started for operation so that pressurized water will be supplied back to the water tank 200 as a cycle; meanwhile, the valve of the safety piping are opened for releasing pressure; one or two of the valves of the 1.5 inch coupling, the reel of hose piping, or the turret piping is opened with the valve of return piping closing so that pressurized water will be spurted from the chosen piping; with the valve of the foam piping opening, foam supplied from the foam tank will flow into the boost pump so that water and foam will be mixed by the boost pump; a foam spout will be spurted from the operating piping for putting off fire.

2. The mobile fire fighting cart as claimed in claim 1, wherein the boost pump is powered by a gas engine; the engine will be started by one of a switch or a rope.

3. The mobile fire fighting cart as claimed in claim 1, wherein a tool box is arranged on the platform for storing hoses and tools.

4. The mobile fire fighting cart as claimed in claim 1, wherein a water pump is arranged to the platform for pumping water from source of water.

5. The mobile fire fighting cart as claimed in claim 1, wherein a cover is placed upon the boost pump for being stepped.
